(19) United States
(12) Patent Application Publication
(10) Pub. No.: US 2003/0202783 A1
(43) Pub. Date: Oct. 30, 2003

(54) Combo system and method capable of restoring operation conditions based on electric power re-supply

(75) Inventor: Byung-hyuk Cho, Suwon City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-City (KR)

(21) Appl. No.: 10/418,123

(22) Filed: Apr. 18, 2003

(30) Foreign Application Priority Data
Apr. 30, 2002 (KR) 2002-23578

(51) Int. Cl. H04N 5/781

(52) U.S. Cl. 386/125; 386/126

(57) ABSTRACT

A system includes a control part which controls operations of a DVD part, and detects and outputs operation information of the DVD part, a controller which controls operations of the control part and a VCR part, and receives the operation information output from the control part, and a storage part which stores the operation information of the DVD part received in the controller. The combo system further includes a power supply part which supplies electric power supplied from an external source to the DVD part and the VCR part, a decision part which determines whether to cut off the electric power supplied to the power supply part, and a low-power supply part which charges low-consumption power necessary to operate the controller during a supplying of the electric power to the power supply part. Where the decision part determines that the electric power supplied to the power supply part is cut off, the low-power supply part supplies the low-consumption power to the controller. The operation information is stored in the storage part which may be provided inside the controller. Accordingly, separate memories are not necessary to store the operation information. Furthermore, the system is capable of restoring operation states of, for example, the DVD part, upon re-supply of the electric power after the cut off of the electric power.

### CROSS-REFERENCE TO RELATED APPLICATIONS

This application claims the benefit of Korean Patent Application No. 2002-23578 filed on Apr. 30, 2002, in the Korean Intellectual Property Office, the disclosure of which is incorporated herein by reference.

### BACKGROUND OF THE INVENTION

1. Field of the Invention

The present invention relates to a system which combines devices having independent functions into one system, and more particularly, to a combo system which combines a DVD part and a VCR part into one system, and restores an operation of the DVD part in response to electric power being re-supplied after being cutoff during the operation of the DVD part.

2. Description of the Related Art

Generally, a “combination system” which combines devices having independent functions into one system is referred to as a “combo system” or a “combo” in short. FIG. 1 shows an example of such a combo system, a DVD/VCR combo system 10, which combines a DVD part 14 and a VCR part 12. That is, the DVD/VCR combo system 10 has the VCR part 12 which carries out general VCR functions, and the DVD part 14 which carries out general DVD functions. The general DVD functions may include reproducing images and sounds recorded on a DVD. In addition to their independent functions, the VCR part 12 and the DVD part 14 may have functions capable of mutually recording image data and sound data retrieved from each other.

A TV 24 can be connected to the DVD/VCR combo system 10 as a peripheral device to output images and sounds reproduced from the VCR part 12 and the DVD part 14. An audio amplifier 22 can be connected to the DVD/VCR combo system 10 as a peripheral device to output sounds reproduced from the DVD part 14. An external device 26 such as a camcorder can also be connected to the DVD/VCR combo system 10 as a peripheral device. The DVD/VCR combo system 10 can record images and sounds input from, for example, the external device 26 on a magnetic tape and an optical disc through the VCR part 12 and the DVD part 14, respectively.

The VCR part 12 and the DVD part 14 in the DVD/VCR combo system 10 exist in one system in appearance, and are manufactured in one case. A user manipulates a separate input device, such as a remote controller (not shown) or an operation panel (not shown) provided on a front of the DVD/VCR combo system 10, so as to switch modes between the VCR part 12 and the DVD part 14, and operate the individual functions of the VCR part 12 and the DVD part 14.

In addition to having the DVD part 14 and the VCR part 12 to replay video and audio data recorded on an optical disc and a magnetic tape, respectively, the DVD/VCR combo system 10 may have a broadcast reception part (not shown), such as a tuner, to receive broadcast signals and output the broadcast signals to an external device, such as the TV 24.

In the conventional DVD/VCR combo system 10, where electric power is re-supplied after being cut off due to power failure during a replaying of an optical disc, the DVD part 14 loads and replays the inserted optical disc from the beginning as a DVD mode is selected to operate the DVD part 14. Accordingly, while a user may desire to view video and/or audio information of the optical disc from a portion retrieved prior to the cutoff of the electric power, the conventional DVD/VCR combo system 10 necessarily requires the user to search from the beginning for the portion retrieved prior to the cutoff of the electric power.

To solve this inconvenience, a method has been proposed to use non-volatile memories (EEPROMs) or flash memories to continuously update sector numbers of an optical disc being reproduced. In the method, where electric power is re-supplied after being cut off during a reproduction operation of a DVD part, the DVD part searches for sector numbers of an inserted optical disc through the sector numbers of the optical disc updated in a non-volatile memory prior to the cutoff of the electric power, according to the reproduction operation of the DVD part, and retrieves a corresponding sector of the optical disc.

However, to implement the above method, the conventional DVD/VCR combo system 10 requires a separate non-volatile memory to store operation states based on a power failure during DVD operations and operation states such as sector numbers of an optical disc. Accordingly, the production cost of the DVD/VCR combo system 10 is raised. In addition, a non-volatile memory mounted to the DVD/VCR combo system 10 has a limited lifespan during which a reading and writing of data can be performed. Therefore, a user may have to replace the mounted flash memory after the reading and writing of the data are carried out for a certain number of times. Furthermore, since a certain period of time is required to record data into a non-volatile memory, where electric power is cut off during recording operation states of the DVD/VCR combo system 10, damage occurs to operation information stored in the non-volatile memory. In such a case, the DVD/VCR combo system 10 can not be restored to the operation states prior to the cutoff of the electric power where the electric power is re-supplied. For at least the above reasons, the method is not applied to real products that continuously record sector numbers of an optical disc in a non-volatile memory.

### SUMMARY OF THE INVENTION

Accordingly, it is an aspect of the present invention to provide a system, for example, a DVD/VCR combo system capable of solving the production cost increase owing to non-volatile memories necessary to store operation states of a DVD part and a VCR part.

Another aspect of the present invention is to provide a system capable of solving the inconvenience of replacing mounted flash memories, after the certain number of reading and writing operations, based on the lifespan of non-volatile memories.

Yet another aspect of the present invention is to provide a system capable of solving one or more problems related to damage occurring to operation information, due to a power failure during a recording of operation states.

Additional aspects and/or advantages of the invention will be set forth in part in the description which follows and, in part, will be obvious from the description, or may be learned by practice of the invention.

To achieve the above and/or other aspects of the present invention, there is provided a system comprising a first device, a control part which controls operations of the first device part and detects operation information of the first device part, and a second device part having a storage part which stores the operation information of the first device art. The first device part may be a DVD part.

The system may further comprise a controller which controls operations of the control part and the second device part, and in response to electric power for the first and second device parts being re-supplied after being cut off, the controller controls the control part based on the operation information stored in the storage part. The controller controls the control part based on the operation information stored in the storage part so as to restore and/or continue to operate the first device part in an operational state prior to the cutoff of the electric power.

The system may further comprise a power supply part which supplies the electric power to the first and second device parts, a decision part which determines whether to cut off the electric power supplied to the power supply part, and a low-power supply part which charges low-consumption power necessary for the controller during a supplying of the electric power to the power supply part, and supplies the low-consumption power to the controller in response to the electric power supplied to the power supply part being cut off.

The system may further comprise an OSD part which displays on-screen selection information to determine whether to continue to operate the first device part in an operational state prior to the cut off of the electric power, in response to the electric power being re-supplied to the system after being cut off. The controller may control the OSD part, and in response to an input signal to continue to operate the first device part in the operational state prior to the cut off of the electric power, operates the control part to restore the first device part according to the operation information stored in the storage part.

The storage part may comprise a first storage part which sequentially stores the operation information, and in response to desired information of the operation information being stored in the first storage part, outputs the operation information having the desired information, and a second storage part which stores the operation information output from the first storage part. The controller may control the storage part so as to update the operation information with updated operation information of the first device part received from the control part, at a predetermined time interval.

The operation information may include mode information which indicates kinds of modes in which the first device part operates, track information which indicates track numbers carried on an optical recording medium according to the modes, data information which indicates kinds of data to be recorded/reproduced from the optical recording medium, current time information which is provided to the system, operation time information which is an operation time at which the first device part has operated as to the optical recording medium, chapter information which is information grouped and edited in a predetermined format for the data, and media information which indicates a format-type of the optical recording medium.

The mode information may include a record mode to record the data on the optical recording medium, and a reproduction mode to reproduce the data from the optical recording medium on which the data is stored, a load mode to load the data, a search mode to search for particular data, and a skip mode to skip to the data recorded on the optical recording medium according to commands of the control part. The kinds of data information may include document data, program data, audio data, video data, data mixed with the audio data and the video data, and booting data. The format-type of the optical recording may include a DVD and a CD.

To achieve the above and/or other aspects of the present invention, there is provided a method of controlling a system including first and second device parts having independent functions, the method comprising detecting operation information of the first device part, storing the operation information in a storage part of the second device part, and maintaining an operational state of the first device part by storing the operation information detected prior to the cutoff of electric power for the system. The method may further comprise restoring the first device part in the operational state prior to the cut off of the electric power based on the operation information stored in the storage part, in response to the electric power being re-supplied to the system after being cut off.

The restoring of the first device part may comprise displaying on-screen selection information to determine whether to continue to operate the first device part in the operational state prior to the cut off of the electric power, in response to the electric power being re-supplied to the system after being cut off, and restoring and performing the first device part according to the operation information stored in the storage part in response to an input signal to continue to operate the first device part in the operational state prior to the cut off of the electric power.

The present invention stores the operation information of the first device part in the storage part which may be provided in the controller of the second device part. Accordingly, a separate storage part such as a flash memory or an EEPROM to store the operation information of the first device part is not needed. Additionally, since the storage part of the controller can be semi-permanently used to store the operation information, the inconvenience of replacing a flash memory or an EEPROM, which has a limited lifespan in comparison, can be avoided.

Furthermore, the present invention stores the operation information, which is stored in the first storage part, in the second storage part before updating the operation information in the first storage part with updated operation information. Therefore, restoration of the operational state prior to the cut off of the electric power is still possible even though the electric power may have been cut off at the instance where the operation information is being updated.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a block diagram of a conventional DVD/VCR combo system which combines a DVD part and a VCR part;

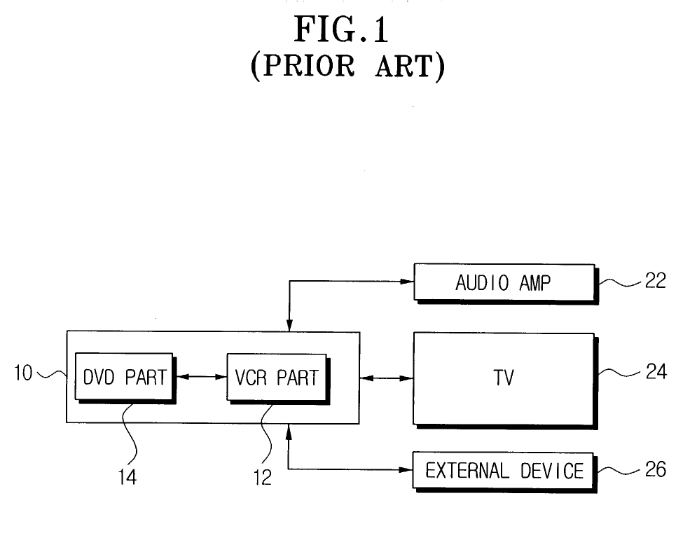

FIG. 2 is a block diagram illustrating a system which combines device having independent functions, for example, a DVD/VCR system according to an embodiment of the present invention;

FIG. 3 is a block diagram illustrating operation information of a DVD part stored in a storage part of FIG. 2, according to the present invention;

FIG. 4 is a block diagram illustrating a VCR controller of FIG. 2 according to the present invention;

FIG. 5 is a block diagram illustrating a DVD part of FIG. 2 according to the present invention;

FIG. 6 is a block diagram illustrating a VCR part of FIG. 2 according to the present invention; and

FIG. 7 is a flow chart illustrating a method of controlling operations of a system which combines devices having independent functions where power is re-supplied after being cut off, according to the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

The present invention relates to a system that combines devices having independent functions into one system having a control part which controls operations of each device and stores information from another control part corresponding to one of the devices onto a storage part which may be provided in the control part corresponding to, for example, another device. The system may be provided in one casing which defines an appearance of the system. Accordingly, while a DVD/VCR combo system is described below to illustrate an aspect of the present invention, it is understood that the present invention is not limited to a combo system or a DVD/VCR combo system. Rather, the present invention can be applied to, for example, any system having control parts, corresponding to devices, that can communicate with each other.

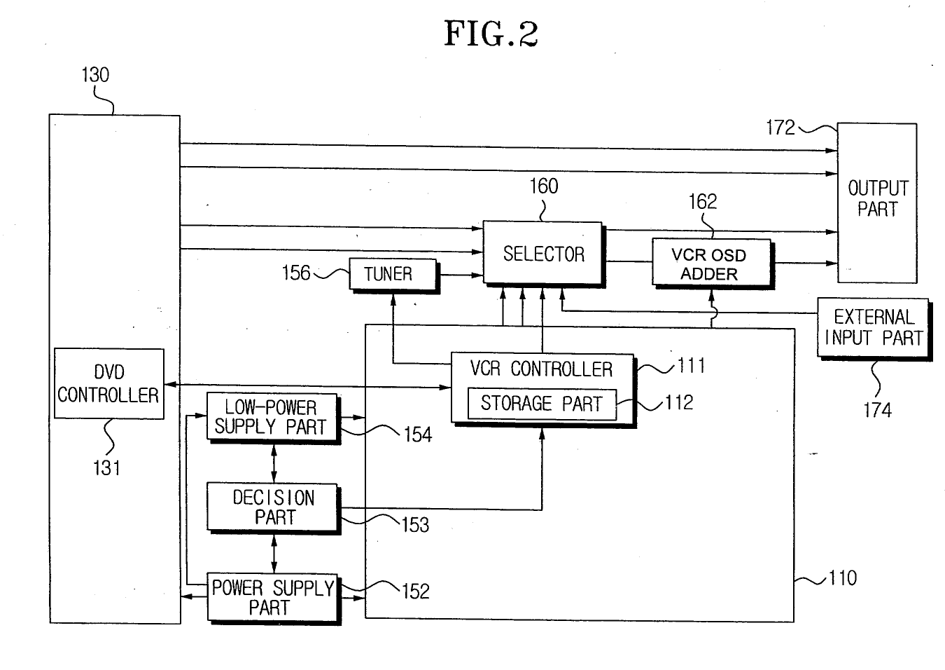

FIG. 2 shows a DVD/VCR combo system according to an embodiment of the present invention. The DVD/VCR combo system includes a VCR part 110, a DVD part 130, an external input part 174, a tuner 156, a selector 160, and an output part 172.

The VCR part 110 performs general VCR functions, including a function which replays image and sound data recorded on a magnetic tape and a function which records image and video data input from an external source on the magnetic tape. The DVD part 130 carries out general DVDP functions, including a function which replays data recorded on optical recording media such as DVDs and CDs. The DVD part 130 may include functions capable of recording data input from external sources, on optical recording media.

The external input part 174 may be connected to an external device such as a camcorder and input sound and image data from the external device. The tuner 156 receives a broadcast signal transmitted through an antenna (not shown) and/or a cable (not shown), tunes to a corresponding channel from the received broadcast signal according to an input tuning command, and outputs the broadcast signal of the tuned channel.

The selector 160 selects and outputs a corresponding signal according to an input selection command from signals output from the VCR part 110, DVD part 130 and tuner 156, and a signal transmitted through the external input part 174. The output part 172 outputs signals output from the DVD part 130 and the selector 160 to a peripheral device such as a TV (not shown) and/or an audio amplifier (not shown).

The DVD/VCR combo system further includes a VCR OSD adder 162 that adds a VCR OSD signal to image data output from the selector 160. The VCR OSD signal can display on a screen as an OSD function, that is, a caption signal for sound and image data provided and output from the VCR part 110.

The DVD part 130 includes a DVD controller 131 which controls the operations of the DVD part 130 according to an input operation command. The VCR part 110 includes a VCR controller 111 which controls the operations of the VCR part 110 and the DVD controller 131 according to an input operation command. In the present embodiment, while electric power necessary for the operation of the DVD part 130 is supplied, the DVD controller 131 detects operation information of the DVD part 130. Then, the DVD controller 131 transfers the detected operation information to the VCR controller 111.

The VCR controller 111 includes a storage part 112 which stores programs necessary for the control of the DVD/VCR combo system, together with setting information, and editing information edited by a user. The storage part 112 of the VCR controller 111 also stores the received operation information of the DVD part 130. The VCR controller 111 may update and store the operation information of the DVD part 130, which is periodically received at a predetermined time interval, in the storage part 112. As electric power necessary for normal operations, such as a replaying, recording, or the like, of the DVD part 130 and the VCR part 110 are cut off and re-supplied, the VCR controller 111 controls the DVD controller 131 so as to have the DVD part 130, which is disenabled due to the cutoff of the electric power, continue to operate based on the operation information stored in the storage part 112 before the electric power is cut off. The storage part 112 is included in the VCR controller 111 as one module, which can be semi-permanently used together with the VCR controller 111.

The DVD/VCR combo system further includes a power supply part 152, a decision part 153, and a low-power supply part 154. The power supply part 152 receives the electric power from a power terminal (not shown), such as a plug, and provides the electric power to the VCR part 110 and the DVD part 130. The VCR part 110 and the DVD part 130 drop voltages of the input electric power to voltages of predetermined levels for use in their respective operations.

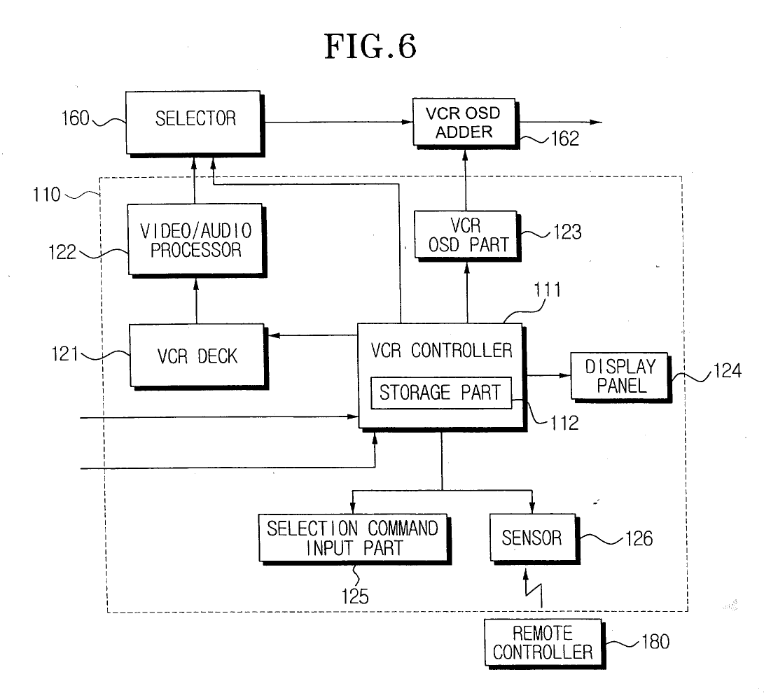

The decision part 153 determines whether to cut off the electric power supplied to the power supply part 152 from the power terminal. While the electric power is supplied to the power supply part 152, the low-power supply part 154 is charged with low-consumption power necessary for control operations of the VCR controller 111. Where the electric power supplied to the power supply part 152 is cut off by the decision part 153, the low-power supply part 154 supplies the low-consumption power to the VCR controller 111. Accordingly, the storage part 112 maintains and stores the operation information of the DVD part 130 using either the dropped voltage of a predetermined level, where the electric power is supplied, or the low-consumption power provided from the low-power supply part 154 where the electric power is cut off.

Where the decision part 153 decides to re-supply the electric power to the power supply part 152, after the cutoff, the VCR controller 111 controls the DVD controller 131 so as to have the DVD part 130, which is disabled due to the cutoff of the electric power, continue to operate based on the operation information stored in the storage part 112. At this time, where the electric power is re-supplied, the VCR controller 111 may control a VCR OSD part (See FIG. 6), which carries out an OSD function, to display onscreen selection information so as to enable a user to select whether to continue the operation of the DVD part 130 based on the operation information stored in the storage part 112.

Although the storage part 112 is depicted as being inside the VCR controller 111, it is understood that the storage part 112 may be disposed outside the VCR controller 111.

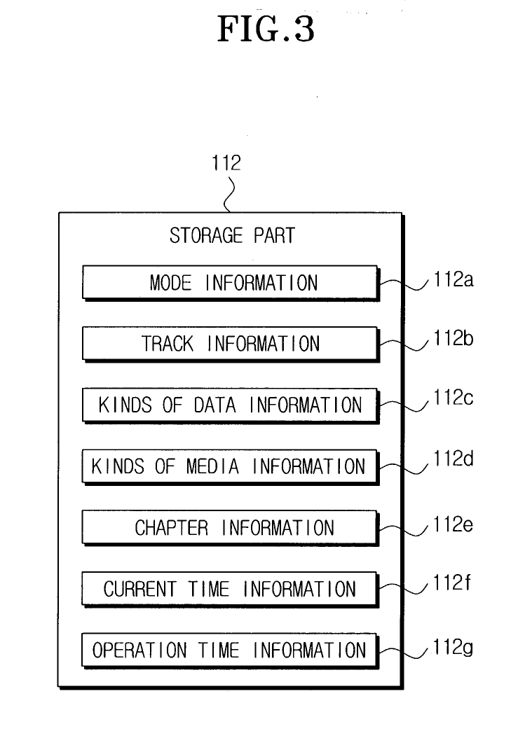

FIG. 3 shows examples of the operation information of the DVD part 130, which can be stored in the storage part 112. As shown in FIG. 3, the operation information includes mode information 112a, track information 112b, kinds of data information 112c, kinds of media information 112d, chapter information 112e, current time information 112f, and operation time information 112g.

The mode information 112a indicates, for example, a type of mode in which to operate the DVD part 130. The type of mode includes, for example, a recording mode to record data on an optical recording medium, a replay mode to replay recorded data from the optical recording medium, a load mode to load data stored on the optical recording medium, based on controls of the DVD controller 131, a search mode to search for particular data, and a skip mode to preview the recorded data on the optical recording medium.

The track information 112b indicates track numbers of the optical recording medium, which are performed according to an operation mode of the DVD part 130. The kinds of data information 112c define the kinds of data recorded on the optical recording medium or retrieved from the optical recording medium. For example, the kinds of data information 112c include document data which is text information based on processing characteristics of data to be recorded or retrieved, program data which is programs, audio data which is audio information, video data which is video information, data mixed with the audio information and the video information, and booting data which is used to boot systems.

The kinds of media information 112d indicates the kinds of optical recording media. For example, the kinds of media information 112d include DVD information which indicates that optical recording media to be recorded or retrieved are DVDs, and CD information which indicates that optical recording media to be recorded or retrieved are CDs. The chapter information is information grouped and edited in a predetermined format for data recorded on or retrieved from an optical recording medium. Where data recorded on an optical recording, medium is movie data, that is, mixed data having audio and video data, types of the chapter information 112e include, for example, chapter information to divide the movie data in a predetermined unit (into folders), chapter information edited to view the summary of the movie data, chapter information edited to view the story of the movie data in text, and chapter information to record information such as the editor's postscript of the movie data.

The current time information 112f is the time set to the DVD/VCR combo system by a user. The operation time information 112g is the operation time at which the DVD part 130 operates as to the optical recording medium.

Accordingly, where the electric power is re-supplied, the VCR controller 111 controls the DVD controller 131 to operate in an operational state prior to the cutoff of the electric power based on the operation information of the DVD part 130 stored in the storage part 112. Therefore, the DVD part 130 can pick up where it left off and continue to perform the operation as if the cut off of the electric power did not occur.

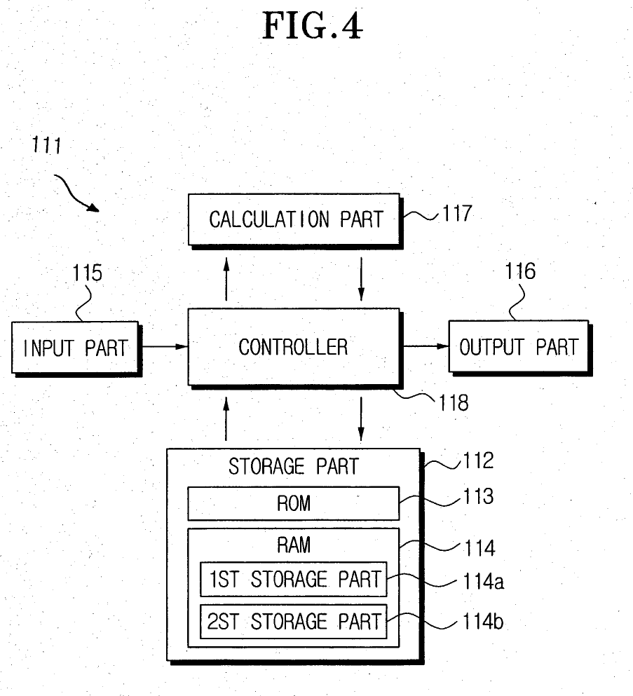

FIG. 4 shows the VCR controller 111 of FIG. 2 in detail. The VCR controller 111 includes an input part 115, an output part 116, the storage part 112, a calculation part 117, and a controller 118.

The input part 115 inputs data from an external source. The output part 116 outputs a processed result value of the input data. The storage part 112 stores the data input into the input part 115. The calculation part 117 processes the data input into the input part 115. The controller 118 controls a series of operations of the input part 115, output part 116, storage part 112, and calculation part 117. In the present embodiment, the input part 115 receives information on operations of the DVD part 130. The controller 118 stores the received operation information in the storage part 112. The storage part 112 includes a ROM 113 and a RAM 114. The ROM 113 stores programs and the like which are necessary for the operations of the DVD/VCR combo system when the system is manufactured. The ROM 113, in which system drive data including programs is stored, only allows initially stored data to be read. The RAM 114 stores data and the like which is edited by a user.

The RAM 114 includes a first storage part 114a and a second storage part 114b. In one method, sequentially, operation information of the DVD part 130 first received is stored in the first storage part 114a, and operation information of the DVD part 130 received in the next time is stored in the second storage part 114b. In another method, the first storage part 114a may sequentially store detailed information, in order of reception, until all of the detailed information of the operation information of the DVD part 130 is stored, and where all of the detailed information is received and stored, the operation information of the DVD part 130, having the detailed information, is output to the second storage part 114b based on set times. The second storage part 114b stores the operation information of the DVD part 130 output from the first storage part 114a. In this case, the second storage part 114b updates the stored operation information to newly input operation information where the new operation information is output from the first storage part 114a. The VCR controller 111 having the above structure may be manufactured in one module, which is referred to as a “micom.”

Accordingly, even though the electric power may be cut off during a storing and updating of the operation information, the loss of the operation information can be prevented. Therefore, the DVD part 130 can return to an operational state prior to the cut off of the electric power even though the electric power may be cut off during the storing or updating of the operation information, where the electric power is re-supplied after being cut off.

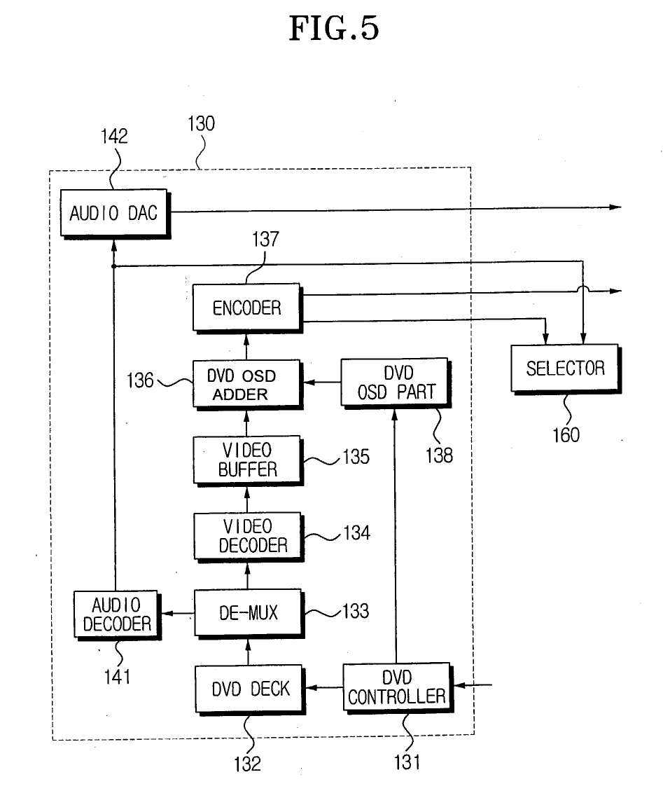

FIG. 5 shows the DVD part 130 of FIG. 2 in detail. The DVD part 130 includes a DVD deck 132, a DE-MUX 133, a video decoder 134, a video buffer 135, an audio decoder 141, a DVD OSD part 138, a DVD OSD adder 136, an encoder 137, an audio DAC 142, and the DVD controller 131. All of the above parts except for the DVD controller 131 and the DVD deck 132 can be structured in one chip.

The DVD deck 132 reads in data recorded on optical recording media such as DVDs, CDs, and so on. Where an optical recording medium, for example, a DVD, is inserted into and seated on the DVD deck 132, the DVD controller 131 switches an operation mode of the DVD part 130 to a replay mode, and loads and replays the DVD inserted in the DVD deck 132. The DVD controller 131 controls the operation of the DVD deck 132 according to an operation command transferred from the VCR controller 111.

The DE-MUX 133 separates data read from the DVD deck 132 into a video signal and an audio signal for its outputs. The video decoder 134 and the audio decoder 141 decode and restore compressed video and audio signals to original digital video and audio signals. The video buffer 135 stores the video and audio signals. The video buffer 135 stores and outputs a predetermined amount of video data output from the video decoder 134. For example, the video buffer 135 stores and outputs a predetermined amount of video data to configure a display of one frame.

The DVD OSD part 138 stores character data and a variety of symbols to be overlaid on a DVD display, and performs the OSD function according to the control of the DVD controller 131. The DVD OSD adder 136 adds video data output from the video buffer 135 and OSD information output from the DVD OSD part 138. The encoder 137 converts a video signal of a digital format into a TV image signal of an analog format for an output thereof. For example, for an image signal to be output, there are a composite image signal corresponding to a CVBS, a super video signal comprising Y/C, a component video signal comprising Y/Pb/Pr, and so on.

The audio DAC 142 converts an audio signal of a digital format output from the audio decoder 141 into an audio signal of an analog format for an output thereof. The DVD controller 131 controls the overall operations of the DVD part 130, and the VCR controller 111 controls the DVD controller 131. The DVD controller 131 detects operation states of the DVD deck 132, and transmits the detected operation information to the VCR controller 111.

FIG. 6 shows the VCR part 110 of FIG. 2 in detail. The VCR part 110 includes a VCR deck 121, a video/audio processor 122, the VCR OSD part 123, a VCR controller 111, a display panel 124, and a selection command input part 125.

The VCR deck 121 records data such as sounds and images on magnetic tapes such as video tapes, or reads data recorded on the magnetic tapes. Where a magnetic tape is inserted in the VCR deck 121, the VCR controller 111 may switch the VCR 110 into a replay mode to replay the magnetic tape inserted into the VCR deck 121. The video/audio processor 122 processes video and audio signals retrieved from the VCR deck 121 into a predetermined signal for an output thereof.

The VCR OSD part 123 produces OSD information according to the control of the VCR controller 111 for an output to the VCR OSD adder 162. Accordingly, the VCR OSD adder 162 adds an image signal output from the selector 160 and OSD information output from the VCR OSD part 123 for an output to the output part 172. Where the electric power is re-supplied after being cut off, the VCR controller 111 controls the VCR OSD part 123 to display OSD information selection menus on a screen (not shown), for a user to select, whether to continuously perform the operation of the DVD part 130 carried out prior to the cutoff of the electric power based on the operation information stored in the storage part 112.

The VCR controller 111 controls the overall operations of the VCR part 110, and stores the operation information of the DVD part 130 transferred from the DVD controller 131 in the storage part 112. The VCR controller 111 may detect and store the operation information of the DVD part 130 as well as operation information corresponding to operation states of the VCR part 110. The VCR controller 111 continuously updates and stores the operation information in the storage part 112 where the electric power is supplied to the power supply part 152 of the DVD/VCR combo system. Where the electric power is cut off, the VCR controller 111 stores the operation information stored in the storage part 112 until the electric power is supplied, and, where new operation information of the DVD part 130 is received, updates the stored operation information into the newly received operation information for storage.

The display panel 124 displays texts, numbers, graphics, and so on, for a user to recognize operation states and setting states of the DVD/VCR combo system, according to the controls of the VCR part 110 and the DVD part 130. The selection command input part 125 is provided with operation keys (not shown) to operate the DVD/VCR combo system, receives selection commands, and transfers them to the VCR controller 111. The VCR part 110 further includes a sensor 126 which receives various operation commands selected through a remote controller 180. A signal sensed in the sensor 126 is transferred to the VCR controller 111.

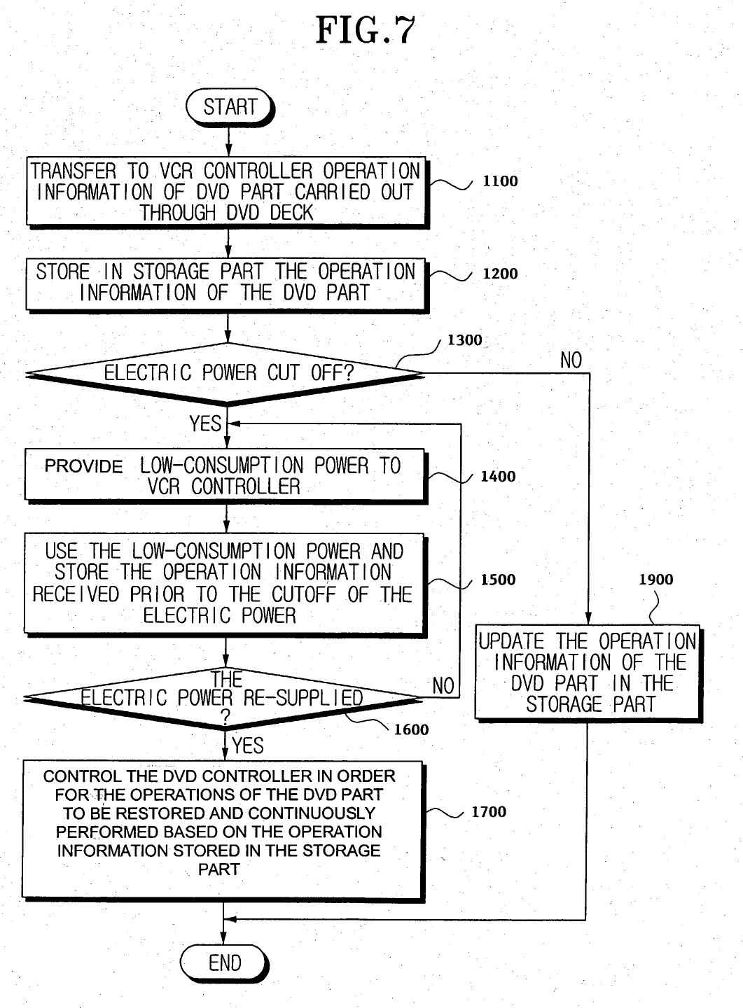

FIG. 7 shows a flow chart illustrating a method of controlling the operations of the DVD/VCR combo system shown in FIG. 2, where electric power supplied thereto is cut off and re-supplied. In operation 1000, the DVD controller 131 detects the operation information of the DVD part 130 carried out through the DVD deck 13 and transfers the detected operation information to the VCR controller 111. The VCR controller 111 stores the operation information transferred from the DVD controller 131 in the storage part 112, in operation 1200. For example, the VCR controller 111 first stores the received operation information in the first storage part 114a, and where new operation information is received, outputs the stored operation information to the second storage part 114b and stores the newly received operation information in the first storage part 114a. The VCR controller 111 stores the operation information output from the first storage part 114a in the second storage part 114b.

In operation 1300, the decision part 153 uses electric power being supplied to the power supply part 152 to determine whether to cut off the electric power supplied to the power supply part 152 during an operation of the DVD/VCR combo system. Where the electric power is decided to be continuously supplied to the power supply part 152, the VCR controller 111 updates and stores the operation information of the DVD part 130 transmitted from the DVD controller 131 in the storage part 112 at a predetermined interval, in operation 1900. Where the electric power supplied to the power supply part 152 is decided to be cut off in the operation 1300, the low-power supply part 154 provides low-consumption power, which is charged during the supply of the electric power to the power supply part 152, to the VCR controller 111 in operation 1400.

The VCR controller 111 uses the low-consumption power provided by the low-power supply part 154 to control the internal operations of the VCR controller 111 in operation 1500. The VCR controller 111 may use the low-consumption power to store the operation information of the DVD part 130, which is received from the DVD controller 131 prior to the cutoff of the electric power, in the storage part 112.

In operation 1600, the decision part 153 determines whether the electric power is re-supplied to the power supply part 152 after being cut off. Where the electric power is not re-supplied, the method returns to the operation 1400. Where the electric power is re-supplied to the power supply part 152 in the operation 1600, the VCR controller 111 controls the DVD controller 131 so as to restore and continuously carry out the operations of the DVD part 130, prior to the cutoff of the electric power, based on the operation information stored in the storage part 112, in operation 1700.

Accordingly, where the electric power is re-supplied after being cut off during the operations of the DVD part 130, the VCR controller 111 controls the DVD controller 131 to restore and continuously perform the operations of the DVD part 130 based on the operation information stored in the storage part 112, to thereby eliminate the inconvenience associated with the cutoff of the electric power while the DVD part 130 is in use. Furthermore, the storage part 112 can be semi-permanently used to store the operation information using the low power supplied from the low-power supply part 154, unlike flash memories, EEPROMs, and so on used by a conventional DVD/VCR combo system having a shortened lifespan in comparison.

Although the present invention has been described with respect to the operation information of the DVD part 130, it is understood that the present invention can detect and store operation information of the DVD part 130 and the VCR part 110. That is, respective operations of the DVD part 130 and the VCR part 110 can be continuously performed, prior to the cutoff of the electric power, based on respectively stored operation information of the DVD part 130 and the VCR part 110 upon re-supply of the electric power after the cutoff.

The present invention stores, for example, the operation information of the DVD part in the storage part 112 provided in the VCR controller. Accordingly, a separate storage part to store the operation information of the DVD part is not needed. Therefore, inconvenience of adding an additional storage part and cost related to thereof can be avoided.

In the present invention, a storage part provided inside a VCR controller can be semi-permanently used to store operation information. Therefore, an inconvenience can be avoided which is associated with the use of flash memories or EEPROMs having a shortened lifespan in comparison (number of times data can be recorded to store operation information).

The present invention stores initially received operation information in a first storage part, updates it with newly received operation information in the first storage part, and updates and stores the initially received operation information stored in the first storage part in the second storage part. Accordingly, operational states can be restored even if electric power is cutoff at the instance where the operation information is being updated.

Finally, while a DVD/VCR combo system has been described, it is understood that the present invention can be applied to a mono system having first and second device parts, wherein operation information of the first device part is stored in a storage part of the second device part.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A system comprising:
a first device part;
a control part which controls operations of the first device part and detects operation information of the first device part; and
a second device part having a storage part which stores the operation information of the first device part.

2. The system of claim 1, further comprising a controller which controls operations of the control part and the second device part, and in response to electric power for the first and second device parts being re-supplied after being cut off, the controller controls the control part based on the operation information stored in the storage part.

3. The system of claim 2, wherein in response to the electric power being re-supplied after being cut off, the controller controls the control part based on the operation information stored in the storage part so as to restore and/or continue to operate the first device part in an operational state prior to the cutoff of the electric power.

4. The system of claim 2, wherein the controller is provided in the second device part, and the control part is provided in the first device part.

5. The system of claim 1, wherein the first device part is a DVD part.

6. The system of claim 1, wherein each of the first and second device parts operates one or more types of recording media.

7. The system of claim 1, wherein the storage part comprises:
a first storage part which sequentially stores the operation information, and in response to desired information of the operation information being stored in the first storage part, outputs the operation information having the desired information; and
a second storage part which stores the operation information output from the first storage part.

8. The system of claim 7, wherein:
the storage part includes a ROM part and a RAM part, and
the RAM part includes the first and second storage parts.

9. The system of claim 7, wherein the controller controls the storage part so as to update the operation information with updated operation information of the first device part received from the control part, at a predetermined time interval.

10. The system of claim 9, wherein the second storage part maintains the operation information, where the first storage part receives the updated operation information, so as to control the second device part based on the operation information stored in the second storage part in response to the electric power being re-supplied after being cut off during the receiving of the updated operation information by the first storage part.

11. The system of claim 1, wherein the storage part comprises
a first storage part which stores the operation information and outputs the stored operation information in response to receiving updated operation information of the first device part; and
a second storage part which stores the operation information output from the first storage part.

12. The system of claim 1, wherein:
the storage part includes first and second storage parts which store the operation information, and
the first and second storage parts alternately store and update the operation information with updated operation information of the first device part at a predetermined interval.

13. The system of claim 2, further comprising:
a power supply part which supplies the electric power to the first and second device parts;
a decision part which determines whether to cut off the electric power supplied to the power supply part; and
a low-power supply part which charges low-consumption power for the controller during a supplying of the electric power to the power supply part, and supplies the low-consumption power to the controller in response to the electric power supplied to the power supply part being cut off.

14. The system of claim 1, further comprising an OSD part which displays on-screen selection information to determine whether to continue to operate the first device part in an operational state prior to the cut off of electric power, in response to the electric power being re-supplied to the system after being cut off.

15. The system of claim 1, further comprising a low-power supply part which provides low-consumption power to maintain the operation information in the storage part, where electric power supplied to the system is cut off.

16. The system of claim 1, wherein:
the first device part operates one or more types of optical recording media, and
the operation information of the first device part includes:
mode information which indicates kinds of modes in which the first device part operates,
track information which indicates track numbers carried on an optical recording medium, operated by the first device part, according to the modes,
data information which indicates kinds of data to be recorded/reproduced from the optical recording medium,
current time information which is a time provided to the system,
operation time information which is an operation time at which the first device part has operated as to the optical recording medium,
chapter information which is information grouped and edited in a predetermined format for the data, and
media information which indicates a format-type of the optical recording medium.

17. The system of claim 16, wherein:
the mode information includes a record mode to record the data on the optical recording medium, a reproduction mode to reproduce the data from the optical recording medium on which the data is stored, a load mode to load the data, a search mode to search for particular data, and a skip mode to skip to the data recorded on the optical recording medium according to commands of the control part,
the data information includes document data, program data, audio data, video data, data mixed with the audio data and the video data, and booting data, and
the format-type of the optical recording medium includes a DVD and a CD.

18. The system of claim 1, further comprising:
an external input part which receives a signal from an external device outside of the system;
a tuner which receives a broadcast signal from the outside of the system;
a selector which selects and outputs a selected signal from one or more of the first device part, second device part, the external input part, and the tuner;
an output part which provides the selected signal output form the selector and a signal output from the first device part; and
a OSD adder which adds a caption signal from the second device part to image data output from the selector.

19. The system of claim 2, wherein the storage part is provided in the controller.

20. The system of claim 1, wherein the system is provided in one casing.

21. The system of claim 1, wherein the system is a system which combines devices having independent functions into one system.

22. The system of claim 1, wherein the system is a combo system which combines the first and second device parts having independent functions.

23. The system of claim 22, wherein the combo system having the first and second device parts is provided in one casing.

24. A method of controlling a system including first and second device parts having independent functions, the method comprising:
detecting operation information of the first device part;
storing the operation information in a storage part of the second device part; and
maintaining an operational state of the first device part by storing the operation information detected prior to a cut off of electric power for the system.

25. The method of claim 24, further comprising restoring the first device part in the operational state prior to the cut off of the electric power based on the operation information stored in the storage part, in response to the electric power being re-supplied to the system after being cut off.

26. The method of claim 25, wherein the restoring of the first device part comprises:
displaying on-screen selection information to determine whether to continue to operate the first device part in the operational state prior to the cut off of the electric power, in response to the electric power being re-supplied to the system after being cut off; and
restoring and performing the first device part according to the operation information stored in the storage part in response to an input signal to continue to operate the first device part in the operational state prior to the cut off of the electric power.

27. The method of claim 24, wherein the storing of the operation information includes updating the operation information with current operation information of the first device part at a predetermined time interval.

28. The method of claim 24, wherein the maintaining of the operational state of the first device part includes maintaining the operation information in the storage part using low-consumption power in response to the electric power being cut off.

29. The method of claim 24, further comprising charging low-consumption power in response to the electric power being supplied to the system, wherein the maintaining of the operational state of the first device part includes maintaining the operation information in the storage part using the low-consumption power where the electric power supplied to the system is cut off.

30. A system comprising first and second device parts having independent functions, wherein a storage part of the second device part stores operation information of the first device part.

31. The system of claim 30, wherein the first device part is a DVD part.

32. The system of claim 30, further comprising a control part which controls an operation of the first device part and outputs the operation information of the first device part.

33. The system of claim 32, further comprising a controller which controls operations of the control part and the second device part.

34. The system of claim 30, further comprising a power supply unit which prevents loss of the operation information in an event of power supply interruption.

35. The system of claim 34, wherein the first device part is a DVD part, and the storage part acts as a separate memory which maintains the operation information of the DVD part based on power supplied from the power supply unit.

36. The system of claim 30, wherein in response to power for the system being re-supplied after being cut off, an operational state of the first device part is restored according to the operation information stored in the storage part.

37. The system of claim 30, wherein the system having the first and second device parts with independent functions is combined into one system.

38. The system of claim 30, wherein the system having the first and second device parts is provided in one casing.

39. The system of claim 33, wherein the storage part is provided in the controller.

40. The system of claim 33, wherein the control part is provided in the first device part, and the controller is provided in the second device part.

41. The system of claim 30, further comprising a low-power supply part which charges low-consumption power during a supplying of power to the system, and supplies the low-consumption power to maintain the operation information in response to the power supplied to the system being cut off.

42. The system of claim 30, wherein the storage part includes one or more storage members so as to maintain the operation information, where the storage part receives updated operation information of the first device part, and to operate the first device part according to the operation information stored in the storage part in response to power being re-supplied after being cut off during the receiving of the updated operation information.

43. The system of claim 30, wherein each of the devices operates one or more types of recording media.
